(19) United States
(12) Patent Application Publication
(10) Pub. No.: US 2004/0071058 A1
(43) Pub. Date: Apr. 15, 2004

(54) Optical disk apparatus

(75) Inventor: Tadashi Tachibana, Osaka (JP)

Correspondence Address: MORGAN LEWIS & BOCKIUS LLP, 1111 PENNSYLVANIA AVENUE NW, WASHINGTON, DC, 20004, US

(73) Assignee: Funai Electric Co., Ltd.

(21) Appl. No.: 10/680,165

(22) Filed: Oct. 8, 2003

(30) Foreign Application Priority Data
Oct. 11, 2002 (JP) P2002-299269

(51) Int. Cl. G11B 7/005

(52) U.S. Cl. 369/47.22; 369/53.34

(57) ABSTRACT

In an optical disc apparatus of the three-beam type, recording and/or reproduction are performed on an optical disc by: irradiating a groove with a main beam; irradiating a first land where address information of the groove is recorded, in front of the main beam with a first side beam; and irradiating a second land where address information adjacent to the groove is recorded, in rear of the main beam with a second side beam. The optical disc apparatus has: an LLP extracting section 18 which extracts an LLP signal from reflected light of the first side beam that irradiates the first land in front of the main beam; and an MPU 20 which calculates the address information on the basis of the extracted LLP signal, thereby pre-reading the address information.

### BACKGROUND OF THE INVENTION

1. Field of the Invention

The present invention relates to an optical disc apparatus, and more particularly to an optical disc apparatus which performs recording and/or reproduction on a DVD-RW optical disc.

2. Description of the Related Art

FIG. 1 is an enlarged view of a recording surface of a DVD-RW optical disc. A groove Gr1 and lands La1, La2 are alternately formed in the surface of the DVD-RW optical disc. The groove Gr1 has pits P used for recording or reproducing video or audio data. In each of the lands La1, La2, land prepits LLP1, LLP2 indicating address information of the groove in which formed on the left side of the land La1 or La2 are embedded. Namely, the land prepits LLP1 embedded in the land La1 indicate the address information of the groove Gr1 which is on the left side of the land La1, and the land prepits LLP2 embedded in the land La2 indicate the address information of the groove (not shown) which is on the left side of the land La2.

In an optical disc apparatus of the three-beam type, a main beam L1 impinges on the groove Gr1, and side beams L2, L3 impinge along the lands La1, La2 which are on the sides of the groove Gr1, respectively. In the example, it is assumed that the main beam L1 and the side beams L2, L3 conduct a scanning operation in a direction from the lower side of the sheet toward the upper side.

From a detection signal based on reflected light of the main beam L1, the optical disc apparatus reads an RF signal based on the pits P, a wobble signal based on wobbles of the grooves and the lands, and an LLP signal (LLP1 and LLP2 signals) based on the land prepits LLP1, LLP2. The address information of the groove Gr1 is obtained by detecting the LLP1 signal based on the land prepits LLP1, and calculating the LLP1 signal.

The side beam L2 impinges along the land La1 on the right side of the groove Gr1 and in front of the main beam L1. The side beam L3 impinges along the land La2 on the left side of the groove Gr1 and in rear of the main beam L1. Reflected light of each of the side beams L2 and L3 is used for judging whether the main beam L1 correctly tracks the groove Gr1 or not.

A conventional optical disc apparatus of the three-beam type is disclosed in, for example, JP-A-2001-266352, JP-A-7-311962, and JP-A-2002-008242.

In the optical disc apparatus disclosed in JP-A-2001-266352, as shown in FIG. 2, reflected light of the main beam L1 is received while splitting the light into two or right and left regions. The difference between a detection signal S31 from the right region and a detection signal S32 from the left region is obtained, and a push-pull signal is calculated. Since the difference between the detection signals S31 and S32 is obtained, in-phase RF signals cancel each other, so that the push-pull signal contains a wobble signal and LLP1 and LLP2 signals as shown in FIG. 3. From the push-pull signal, the LLP1 signal based on the right land prepits LLP1 is extracted with using a threshold (A), the LLP2 signal based on the left land prepits LLP2 is extracted with using a threshold (B), and the wobble signal is extracted with using a threshold (C). The address information of the groove Gr1 is calculated from the LLP1 signal based on the right land prepits LLP1.

In the optical disc apparatus disclosed in JP-A-7-311962, the differences between the main beam L1 and the side beams L2, L3 are obtained to cancel influences of crosstalks in the detection signal of the main beam L1.

In the optical disc apparatus disclosed in JP-A-2002-008242, the detection signal of the side beams L2, L3 is multiplied by a value“k”, and the multiplication result is subtracted from the detection signal of the main beam L1, thereby reducing influences of crosstalks.

In the optical disc apparatus disclosed in JP-A-2001-266352, the difference between the detection signals S31 and S32 is obtained, and the RF signals cancel each other to produce the push-pull signal. However, the push-pull signal often contains high-frequency noises. In such a case, there is the possibility that it is difficult to correctly detect the LLP1 signal with using the threshold (A).

As shown in FIG. 1, the land prepits LLP1 only passes over an outer peripheral portion of the main beam L1. Therefore, the LLP1 signal contained in the push-pull signal has small amplitude and is susceptible to noises. In the case of a recorded optical disc, particularly, there is the possibility that the signal is buried in recorded signals and the S/N ratio is lowered.

In the optical disc apparatus disclosed in JP-A-7-311962, influences of crosstalks in the main beam L1 are canceled with using the side beams L2, L3. However, the publication describes nothing about detection of an LLP signal.

Also in the optical disc apparatus disclosed in JP-A-2002-008242, influences of crosstalks in the main beam L1 are canceled with using the side beams L2, L3. However, the publication describes nothing about detection of an LLP signal.

### SUMMARY OF THE INVENTION

It is therefore an object of the invention is to provide an optical disc apparatus in which an LLP signal can be correctly read and address information can be correctly obtained.

In order to achieve the object, according to a first aspect of the invention, there is provided an optical disc apparatus of a three-beam type in which performs at least one of recoding information on an optical disc and reproducing the information recorded on the optical disc by: irradiating a main beam on a groove formed on the optical disc; irradiating a first side beam on a first land in which address information of the groove is recorded and formed adjacent to the groove, at a position in front of the main beam; irradiating a second side beam on a second land in which address information of a groove adjacent to the groove is recorded and formed opposite to the first land, at a position in rear of the main beam, the apparatus including: a unit configured to extract an LLP signal from reflected light of the first side beam, and to calculate the address information on the basis of the LLP signal, thereby pre-reading the address information.

According to a second aspect of the invention, there is provided an optical disc apparatus of a three-beam type in which performs at least one of recoding information on an optical disc and reproducing the information recorded on the optical disc by: irradiating a main beam on a groove formed on the optical disc; irradiating a first side beam on a first land in which address information of the groove is recorded and formed adjacent to the groove; irradiating a second side beam on a second land in which address information of a groove adjacent to the groove is recorded and formed opposite to the first land, the apparatus including: a LLP extracting unit configured to extract an LLP signal from reflected light of the first side beam; and an address calculating unit configured to calculate the address information on the basis of the LLP signal.

According to a third aspect of the invention, there is provided an optical disc apparatus of a three-beam type in which performs at least one of recoding information on an optical disc and reproducing the information recorded on the optical disc, the apparatus including: a first irradiating unit configured to irradiate a main beam on a groove formed on the optical disc; a second irradiating unit configured to irradiate a first side beam on a first land in which address information of the groove is recorded and formed adjacent to the groove; a third irradiating unit configured to irradiate a second side beam on a second land in which address information of a groove adjacent to the groove is recorded and formed opposite to the first land; an extracting unit configured to extract an LLP signal from reflected light of the first side beam; and a control unit configured to calculate the address information on the basis of the LLP signal.

### BRIEF DESCRIPTION OF THE DRAWINGS

The above objects and advantages of the present invention will become more apparent by describing a preferred exemplary embodiment thereof in detail with reference to the accompanying drawings, wherein:

FIG. 1 is an enlarged view of a recording surface of a DVD-RW optical disc;

FIG. 2 is a view illustrating splitting of a main beam;

FIG. 3 is a view showing relationships of a push-pull signal, a wobble signal, and LLP signals;

FIG. 4 is a functional block diagram of an optical disc apparatus of an embodiment according to the invention; and

FIG. 5 is a view showing a detection signal due to a side beam L2.

### DETAILED DESCRIPTION OF THE PREFERRED EMBODIMENTS

Referring now to the accompanying drawings, a description will be given in detail of a preferred embodiment of the invention.

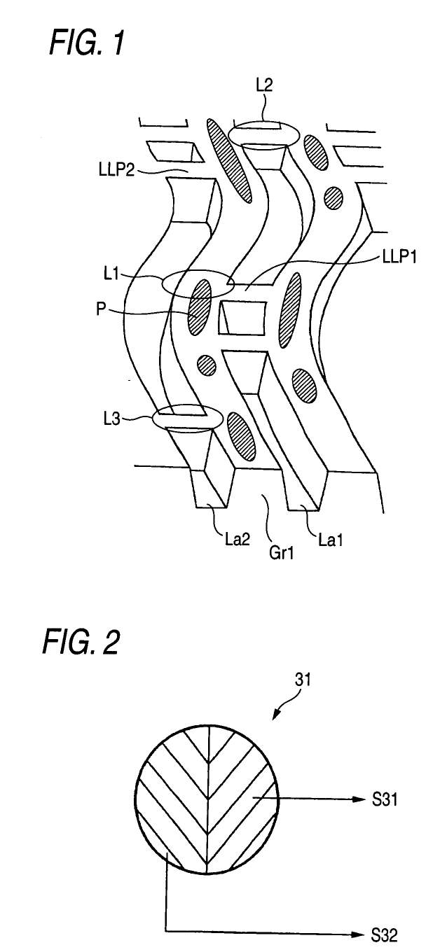

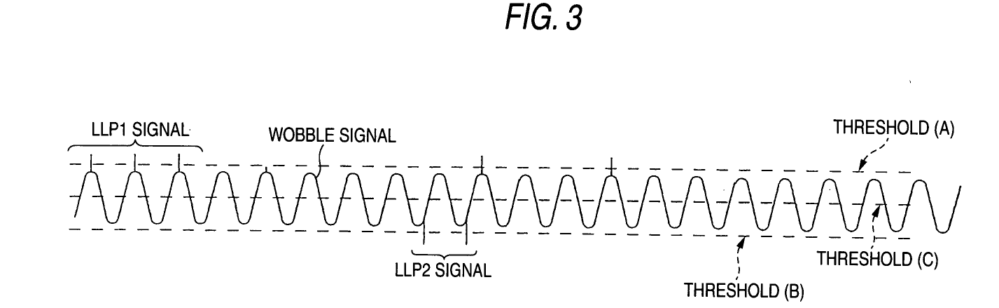

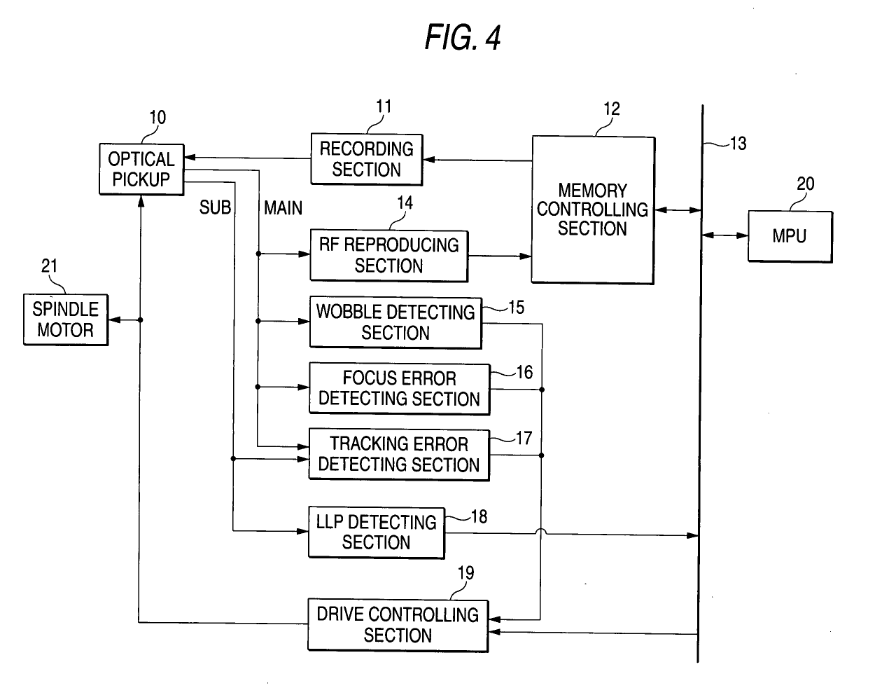

FIG. 4 is a functional block diagram of an optical disc apparatus of an embodiment. The optical disc apparatus is used for recording and reproducing information onto and from an optical disc by the DVD-RW method, or performs recording and reproduction on an optical disc in which grooves and lands are formed as shown in FIG. 1.

The optical disc apparatus mainly includes an optical pickup 10, a recording section 11, a memory controlling section 12, an RF reproducing section 14, a wobble detecting section 15, a focus error detecting section 16, a tracking error detecting section 17, an LLP detecting section 18, a drive controlling section 19, an MPU 20, and a spindle motor 21.

The optical pickup 10 has a laser diode and a photodetector to irradiate the optical disc with a laser beam emitted from the laser diode, and detect reflected light of the laser beam with using the photodetector. The optical pickup 10 is of the three-beam type, and, as shown in FIG. 1, irradiates the optical disc with the laser beam which is emitted from the laser diode while being split into a main beam L1 and side beams L2, L3.

The recording section 11 drives the laser diode of the optical pickup 10 on the basis of recording data received from the memory controlling section 12, so that the data is recorded onto the optical disc.

The memory controlling section 12 is connected to the recording section 11, the RF reproducing section 14, and a bus 13, supplies the recording data received through the bus 13 to the recording section 11, and outputs reproduction data received from the RF reproducing section 14 to the bus 13.

The RF reproducing section 14 receives detection signals due to the main beam L1 from the optical pickup 10, extracts an RF signal, and decodes the RF signal to a reproduction signal.

The wobble detecting section 15 produces a push-pull signal from the difference between the detection signals of right and left regions of the main beam L1, and extracts a wobble signal from the push-pull signal.

For example, the focus error detecting section 16 adds and subtracts each other detection signals of four-divided regions of the main beam L1 to calculate a focus error.

The tracking error detecting section 17 calculates the differences between the detection signals of the right and left regions of the main beam L1, between the detection signals of the right and left regions of the side beam L2, and between the detection signals of the right and left regions of the side beam L3, and subtracts the differences of the side beams L2 and L3 from the difference of the main beam L1, thereby calculating a tracking error.

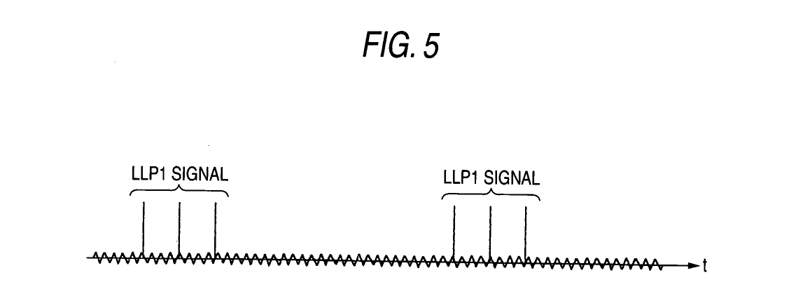

The LLP detecting section 18 extracts an LLP signal from the detection signal due to the side beam L2. The side beam L2 passes over the land prepits LLP1. In the detection signal due to the side beam L2, therefore, an LLP1 signal appears as shown in FIG. 5 without being buried in other signals, noises, and the like. When noise components are eliminated from the detection signal due to the side beam L2 and the LLP signal is obtained from the detection signal, the LLP signal can be obtained more correctly than the case where the LLP signal is obtained from the detection signal due to the main beam L1. The LLP detecting section 18 transmits the extracted LLP signal to the MPU 20 via the bus 13.

The MPU 20 is connected to the memory controlling section 12 via the bus 13 to control the memory controlling section 12. The MPU 20 is connected to the LLP detecting section 18 via the bus 13, produces address information on the basis of the LLP signal extracted by the LLP detecting section 18, and outputs the address information to the drive controlling section 19.

On the basis of the wobble signal, the focus error, the tracking error, and the address information, the drive controlling section 19 drives the optical pickup 10 so as to perform focusing and tracking operations, and drives also the spindle motor 21 to rotate the optical disc.

In the optical disc apparatus, the LLP detecting section 18 extracts the LLP1 signal from the detection signal due to the side beam L2, and the MPU 20 produces the address information from the extracted LLP1 signal and supplies the address information to the drive controlling section 19. On the basis of the address information and also the wobble signal, the focus error, and the tracking error, the drive controlling section 19 drives the optical pickup 10 and the spindle motor 21.

In the optical disc apparatus, the LLP1 signal is not extracted from the detection signal due to the main beam L1, but the LLP detecting section 18 extracts the LLP1 signal from the detection signal due to the side beam L2 which scans over the land prepits LLP1. Therefore, the LLP signal is not buried in other signals and noises, and hence can be correctly extracted. Since the MPU 20 produces the address information on the basis of the LLP1 signal which has been correctly extracted, the correct address information can be obtained.

Even when the LLP1 signal is to be read from a recorded optical disc, the detection signal due to the side beam L2 which scans over the land prepits LLP1 contains substantially only the LLP1 signal. Therefore, the LLP signal is not buried in other signals and noises, and hence can be correctly extracted.

Since the LLP1 signal is read with using the side beam L2 which is in front of the main beam L1, the address information is pre-read at a timing which is earlier by a degree corresponding to the advanced position of the side beam L2 than the case where the LLP1 signal is read with using the main beam L1. Therefore, it is possible to leave a margin for a process time of recording or reproduction by the main beam L1.

In the embodiment described above, the optical pickup 10 corresponds to a unit including all of a first irradiating unit, a second irradiating unit and a third irradiating unit of the invention. Also, in the embodiment described above, the LLP detecting section 18 corresponds to an LLP extracting unit and an extracting unit of the invention, and the MPU 20 corresponds to an address calculating unit and a control unit of the invention.

According to the present invention, in an optical disc apparatus, an LLP signal can be correctly read and address information can be correctly obtained.

According to the present invention, an LLP signal is extracted from reflected light of the first side beam which irradiates the first land in front of the main beam, and the address information is calculated on the basis of the extracted LLP signal, thereby pre-reading the address information.

In the optical disc apparatus according to the present invention, the LLP signal is not extracted from the main beam, but read from the first side beam which irradiates the first land where the address information is recorded. Therefore, the LLP signal is not buried in other signals, and hence can be correctly read. Since the address information is calculated on the basis of the LLP signal, the address information can be correctly obtained.

In the optical disc apparatus according to the present invention, the LLP signal is read from the first side beam which irradiates the first land in front of the main beam, to pre-read the address information. Therefore, it is possible to leave a margin for a process time of recording or reproduction by the main beam.

In the optical disc apparatus according to the present invention, the LLP signal is not extracted from the main beam, but read from the first side beam which irradiates the first land where the address information is recorded. Therefore, the LLP signal is not buried in other signals, and hence can be correctly read. Since the address information is calculated on the basis of the LLP signal, the address information can be correctly obtained.

The optical disc apparatus according to the present invention may be configured so that, in the optical disc apparatus of the second aspect of the invention, the first side beam irradiates the first land in front of the main beam, and the second side beam irradiates the second land in rear of the main beam.

In the above configuration, the first side beam irradiates the first land in front of the main beam. Namely, the LLP signal is read by the first side beam in front of the main beam, and the address information is pre-read. Therefore, it is possible to leave a margin for a process time of recording or reproduction by the main beam.

Although the present invention has been shown and described with reference to a specific preferred embodiment, various changes and modifications will be apparent to those skilled in the art from the teachings herein. Such changes and modifications as are obvious are deemed to come within the spirit, scope and contemplation of the invention as defined in the appended claims.

What is claimed is:

1. An optical disc apparatus of a three-beam type in which performs at least one of recoding information on an optical disc and reproducing the information recorded on the optical disc by: irradiating a main beam on a groove formed on the optical disc; irradiating a first side beam on a first land in which address information of the groove is recorded and formed adjacent to the groove, at a position in front of the main beam; irradiating a second side beam on a second land in which address information of a groove adjacent to the groove is recorded and formed opposite to the first land, at a position in rear of the main beam, the apparatus comprising:
a unit configured to extract an LLP signal from reflected light of the first side beam, and to calculate the address information on the basis of the LLP signal, thereby pre-reading the address information.

2. An optical disc apparatus of a three-beam type in which performs at least one of recoding information on an optical disc and reproducing the information recorded on the optical disc by: irradiating a main beam on a groove formed on the optical disc; irradiating a first side beam on a first land in which address information of the groove is recorded and formed adjacent to the groove; irradiating a second side beam on a second land in which address information of a groove adjacent to the groove is recorded and formed opposite to the first land, the apparatus comprising:
a LLP extracting unit configured to extract an LLP signal from reflected light of the first side beam; and
an address calculating unit configured to calculate the address information on the basis of the LLP signal.

3. The optical disc apparatus as claimed in claim 2, wherein the first side beam is irradiated at a position in front of the main beam, and
wherein the second side beam is irradiated at a position in rear of the main beam.

4. An optical disc apparatus of a three-beam type in which performs at least one of recoding information on an optical disc and reproducing the information recorded on the optical disc, the apparatus comprising:
a first irradiating unit configured to irradiate a main beam on a groove formed on the optical disc;
a second irradiating unit configured to irradiate a first side beam on a first land in which address information of the groove is recorded and formed adjacent to the groove;
a third irradiating unit configured to irradiate a second side beam on a second land in which address information of a groove adjacent to the groove is recorded and formed opposite to the first land;
an extracting unit configured to extract an LLP signal from reflected light of the first side beam; and
a control unit configured to calculate the address information on the basis of the LLP signal.

5. The optical disc apparatus as claimed in claim 4, wherein the first irradiating unit irradiates the first side beam at a position in front of the main beam, and
wherein the second irradiating unit irradiates the second side beam at a position in rear of the main beam.
